(19) United States
(12) Patent Application Publication
(10) Pub. No.: US 2012/0296793 A1
(43) Pub. Date: Nov. 22, 2012

(54) Rate-negotiated, standardized-coupon financial instrument and method of trading

(76) Inventors: Donald R. Wilson, JR., Chicago, IL (US); YuHua Yu, Chicago, IL (US); Michael A. Riddle, JR., Palatine, IL (US)

(21) Appl. No.: 13/068,781

(22) Filed: May 19, 2011

(51) Int. Cl. G06Q 40/00

(52) U.S. Cl. 705/37

(57) ABSTRACT

In accordance with the principles of the present invention, a rate-negotiated, standardized-coupon financial instrument and method of trading are provided. A coupon is negotiated between two parties. At least one forward curve and a discount curve are implied or approximated to be consistent with the negotiated coupon. A consistent value for a swap with a different coupon is determined. The consistent value can comprise the net present value (NPV) of the interest rate swap written as the difference between the present values of two interest payment legs. In the case of a vanilla swap the two legs correspond to fixed coupon payments and floating coupon payments. In the case of a basis swap, one leg is the floating coupon payments with a reference rate plus a fixed coupon, and the other leg is floating coupon payments with a different reference rate. The rate-negotiated, standardized-coupon financial instrument of the present invention provides for a financial instrument negotiated in rate terms to be substituted with an equivalent position in an instrument with a different coupon rate, at an adjusted price.

### FIELD OF THE INVENTION

The present invention relates to financial instruments, and to the electronic clearing and settling of such financial instruments.

### BACKGROUND OF THE INVENTION

A variety of different types of financial instruments are traded throughout the world. Examples include cash contracts and derivatives. A cash contract is an agreement to deliver the specified asset. A derivative is a financial instrument whose value is linked to the price of an underlying commodity, asset, rate, index, currency or the occurrence or magnitude of an event. Typical examples of derivatives include futures, forwards, options, and swaps.

Most commonly, a swap is an agreement between two parties to exchange sequences of cash flows for a set period of time. Usually, at the time the swap is initiated, at least one of these series of cash flows is benchmarked to an asset or an index that is variable, such as an interest rate, foreign exchange rate, equity price or commodity price. A swap may also be used to exchange one security for another to change the maturity (bonds), quality of issues (stocks or bonds) or to facilitate a change in investment objectives.

A nomenclature has developed to describe the characteristics of certain swaps. A “plain-vanilla” swap is one that only has the simplest and most common terms. A “spot” starting swap is one where the economics of the swap start almost immediately upon two parties entering into the swap. A “seasoned” swap is one that has been in existence for some time. A “forward-starting” swap is one where the first calculation date of the swap does not commence until a designated point in the future. The parties to a forward-starting swap are still responsible for performing their obligations, but these obligations do not start for a period of time after the parties have agreed to enter into the swap. An “off-market” swap is one that has a value other than zero at initiation.

The first swap occurred between IBM and the World Bank in 1981. Although swaps have only been trading since the early 1980's, they have exploded in popularity. In 1987, the swaps market had a total notional value of $865.6 billion; by mid-2006, this figure exceeded $250 trillion. That is more than 15 times the size of the U.S. public equities market.

The most common type of swap is an interest rate swap. In a plain-vanilla, interest rate swap, two parties agree to exchange periodic interest payments, typically when one payment is at a fixed rate and the other varies according to the performance of an underlying reference rate. Interest rate swaps are generally quoted in yield terms, especially for par swaps. Conceptually, an interest rate swap can be viewed as either a portfolio of forwards, or as a long (short) position in a fixed-rate bond coupled with a short (long) position in a floating-rate bond. Commonly, for U.S. dollar denominated interest rate swaps, the rate quoted is the fixed rate that the market expects will offset future 3-month London InterBank Offered Rate (LIBOR) (or whatever underlying reference rate is specified in the swap). (LIBOR refers to a daily reference rate based on the interest rates at which banks borrow unsecured funds from other banks in the London wholesale interbank market.) Cash then flows on a periodic basis between the buyer and the seller depending on the difference between the fixed rate and the floating rate. For example, one party (Party A) agrees to pay another party (Party B) a predetermined, fixed rate of interest on a notional amount on specific dates for a specified period of time; concurrently, Party B agrees to pay Party A floating interest rate on that same notional amount on the same specified dates for the same specified time period. Interest payments may be made annually, quarterly, monthly or at any other interval determined by the parties.

Other than plain-vanilla interest rate swaps, float-for-float swaps (also known as basis swaps) are widely used in the market place as hedging and investment tools. A float-float swap involves the exchange of two floating payments with different reference rates between counterparties. The frequency of the two floating payments may or may not be same. For example, in a 3/6 LIBOR basis swap, one party (Party A) agrees to pay another party (Party B) floating interest rate tied to 3-month LIBOR on a predetermined notional amount every three months; concurrently, Party B agrees to pay Party A floating interest rate tied to 6-month LIBOR on that same notional amount every 6 months. In a Fed Funds/LIBOR basis swap, one floating payment is determined by the Federal Funds Effective overnight rate over a certain period, and the other floating payment is determined by LIBOR. The interest payments are commonly made every quarter in a Fed Funds/LIBOR basis swap. The Federal Funds Effective overnight rate is the interest rate at which a depository institution lends immediately available funds to another depository institution overnight.

Standardized derivatives have traditionally been exchange-traded and centrally-cleared financial instruments; swaps, on the other hand, have traditionally been customized financial instruments that are traded in the over-the-counter (OTC) market. (The OTC market most commonly refers to privately negotiated trades between two parties that are not centrally cleared (i.e. uncleared)). Each party looks solely to the other party for performance and is thus exposed to the credit risk of the other party (often referred to as counterparty risk). Unlike financial instruments that are centrally cleared, there is no independent guarantor of performance. Uncleared swaps are often transacted pursuant to International Swaps and Derivatives Association (ISDA) master documentation. The ISDA, 360 Madison Avenue, 16th Floor, New York, N.Y. 10017 is an association formed by the privately negotiated derivatives market that represents participating parties.

It is common for collateral to change hands as the value of an uncleared position changes. The party that has an unrealized loss on an open, uncleared position will post collateral with the party that has the unrealized gain in order to secure its liability. A common form of collateral is obligations of the United States Treasury (i.e. Treasury Bonds, Notes, and Bills). When a Treasury obligation is posted as collateral, price changes in that financial instrument and coupon payments accrue to the owner of the collateral, that being the party posting the financial instrument. Cash may also be posted as collateral, in which case the party receiving the cash as collateral is obligated to pay interest to the party posting the cash collateral at a rate set by agreement between the parties. When the trade is unwound or expires, the party holding the collateral returns it to the other party, and the trade is ultimately settled.

Financial instruments traded on exchanges are distinctly different from uncleared financial instruments. While the economics of the two may be similar, futures and options on futures (futures options) are traded on and pursuant to the rules of an exchange. Unlike uncleared financial instruments where the parties set the terms of the trade, exchange-listed futures and futures options are standardized. Such terms include notional amount, price change per increment, expiration date, and how the financial instrument is settled (either cash settlement or physical delivery) at expiration. The only attributes that matter for parties to negotiate in futures, other than which party is the buyer and which party is the seller, is the number of financial instruments to be traded and the price.

All futures and futures options are centrally cleared, with a central counterparty exchanging payments and collections between counterparties on a regular basis. This is quite different from uncleared financial instruments discussed above. Central clearing means that the counterparty risk is removed. The parties to a trade cease to be counterparties to each other; rather, each party faces a clearinghouse and looks solely to the clearinghouse for clearing trades, collecting and maintaining margin, regulating delivery, and reporting trading data. Traditional, uncleared OTC interest rate swaps can be divided into two categories: “par swaps”, where the initial value of the two legs (the payments that one party pays and receives) are equal; and “off-market swaps,” where one of the legs is more valuable than the other leg when measured in net present value (NPV) terms.

In an uncleared par swap, counterparties typically do not exchange cash or securities at the time of the trade. As the value of the position deviates from par over the life of the swap, counterparties exchange collateral according to the terms of their ISDA rules. In a cleared par swap, counterparties are typically required to post cash or other securities to a clearing agent at the time of the trade, to serve as “initial margin”, which is also known as “performance bond”. The purpose of the initial margin is to ensure that if one counterparty defaults on the trade at a later time by failing to make required payments, the clearing agent can liquidate the position and have sufficient capital available (including the value of the liquidated swap position, and the liquidation value of original collateral posted as initial margin) to pay the non-defaulting counterparty the full amount due.

Typically, a trader who desires to enter into a par swap for a plain vanilla instrument contacts a dealer to find out what fixed coupon rate the dealer will offer as par for a swap defined by certain characteristics. These characteristics can include effective date, fixing date, tenor, maturity date, index, fixed leg payment intervals, floating leg payment intervals, fixed leg day count convention, floating leg day count convention, and holiday calendar, among others. The par coupon rate is expressed in terms of percentage of notional value, and defines the total annual payments due from fixed leg payer to the fixed leg receiver. For example, a par coupon rate of 3.005% on a swap with a notional value of $100 million implies that the fixed leg payer agrees to pay the fixed leg receiver $3,005,000 per year for the tenor of the swap, with such annual amount being divided equally over the number of payments within the year. The most common fixed leg payment interval is semiannual, implying a payment amount of $1,502,500 every six months in this example.

Before a par swap trade is consummated, the counterparties must agree on the “par coupon”, which is the fixed rate coupon that implies an NPV of zero, considering the characteristics of the swap and forecasted future interest rates. Swap traders employ a variety of publicly-available and custom tools to calculate the appropriate par coupon rate, including market data services (for example, Bloomberg L.P., 731 Lexington Avenue, New York, N.Y. 10022 and Thomson Reuters, 3 Times Square, New York, N.Y. 10036); analytical software packages (for example, the RiskVal RVFI Platform, available from RiskVal Financial Solutions, 120 West 31st Street, New York, N.Y. 10001 and SuperDerivatives SDX Interest Rates, available from SuperDerivatives Inc., 545 Madison Avenue, 17th Floor, New York, N.Y. 10022); and custom-constructed spreadsheets.

A typical example of a tool used extensively by swap traders for calculating the par coupon of a given swap is the Bloomberg SWPM swap manager. On the Bloomberg SWPM swap manager, a swap trader can input the characteristics of a swap as described above, and the SWPM swap manager will examine current forecasted interest rates, calculate the fixed coupon rate that implies an NPV of zero (fixed leg PV minus floating leg PV equals zero), and outputs this value to the user as the par coupon.

Similar to the par coupon in vanilla swaps, counterparties who trade a basis swap at par must agree on a “par spread”. Par spread is the interest payment adding to one floating leg such that the present value of this leg is equal to the present value of the other floating leg at the time of trading.

Off-market swaps are swaps that, by definition, have an NPV other than zero at the time of the trade. This NPV must be agreed upon by the counterparties for a trade to be consummated. In an uncleared swap, the negotiated NPV is paid from one counterparty to the other at the time of the trade as an “upfront payment”, generally in cash. As yet, no clear standard market convention has emerged for central counterparties to accommodate off-market swaps for cleared interest rate swaps and cleared swap futures. One method, employed by International Derivatives Clearing Group, LLC (IDCG), 150 East 52nd Street, 5th Floor, New York, N.Y. 10022, is to have the counterparties exchange upfront payments at the time of the trade, in a bilateral fashion without involving the central counterparty. Another method, employed by CME Clearing for cleared interest rate swaps, is to have the upfront payment be exchanged between the counterparties through the central counterparty on the same day that the trade is marked in the favor of the counterparty making the upfront payment, effectively netting out the payment amounts, except for any presumably small difference between the negotiated upfront payment amount and the actual deviation from fair market value determined by the central counterparty. A third method, employed by CME Clearing for clearing Eris Exchange futures, is to embed the negotiated upfront payment amount into the price of the trade itself, and then pay/collect variation margin between the parties only insofar as the fair market value of the future deviates from that trade price in the future.

To initiate a negotiation of NPV for a given off-market swap, the counterparties must first agree on the swap characteristics discussed above. In addition, the counterparties must also agree on the fixed rate coupon of the vanilla swap (or spread in the case of the basis swap), to provide sufficient data to evaluate the NPV of the swap. Once the parties agree on a negotiated NPV, the trade is consummated. The following table summarizes the way that NPV and Fixed Rate are agreed upon for vanilla Par Swaps and Off-Market Swaps:

| | Defined Prior to | Agreed upon during |
|---|---|---|
| | Negotiation | negotiation |
| Par Swap | NPV = 0 | Par Coupon (Fixed Rate) |
| Off-Market Swap | Fixed Rate | NPV (upfront payment) |

Since the spread in a basis swap can be treated as a special form of a coupon, the terms of coupon and spread will not be explicitly distinguished in the following. Coupon can refer to both the fixed rate coupon in a vanilla swap or spread in a basis swap.

For a number of reasons, the majority of trades in the interest rate swap market are negotiated in rate terms as par swaps, for which market participants demonstrate a clear preference. OTC par swaps typically do not involve an upfront exchange of cash between the counterparties. Most ISDA swaps do not require either counterparty to post initial margin, and by definition a par swap has an NPV of zero at the time of the trade, requiring neither counterparty to post collateral to the other upon trade inception.

Cleared par swap derivatives, on the other hand, require each counterparty to post initial margin to the central counterparty (CCP). OTC off-market swaps require an upfront exchange of cash between the counterparties to offset the difference expected value of the future cash flows. Market participants properly recognize the implicit loan that is embedded in this transaction, in that the value exchanged from one counterparty is repaid in periodic installments to the other counterparty throughout the life of the swap, all else being equal. To ensure that appropriate returns are earned for this lending, the majority of OTC dealers employ internal funding models within their banks, to ensure that swap traders properly incorporate lending and borrowing rates on upfront payments for all off-market swaps, and tear-up payments related to unwinds.

Additionally, off-market swaps sometimes require accounting treatment deemed to be unfavorable by swap counterparties. Certain firms use swaps only if they can construct them in such a way as to obtain a specific application of hedge accounting treatment under the Financial Accounting Standards Board (FASB) standards outlined in FAS 133. Obtaining this treatment ensures that the changes in value of the swap over the course of the swap's duration do not get reported through the income statement of the firm. Off-market swaps with upfront payments are generally disqualified from receiving this form of accounting treatment. The FASB establishes standards of financial accounting and reporting nongovernmental entities.

The factors related to off-market swaps—especially upfront payments that amount to off-balance sheet loans that require funding and invoke unfavorable accounting treatment—are further reasons that explain the clear preference among market participants to trade OTC interest rate swaps as par swaps. This is referred to herein as the upfront payment issue. The relative popularity of par swaps compared to off-market swaps may be largely attributable to the upfront payment issue, but also may be self-reinforcing over time. Given the maturity of the swap market and the amount of tools available to traders that focus analysis on par swaps, attempts to list swap-like products that do not trade as par swaps will be forced to overcome what will be referred to herein as the preference for par swaps issue.

Traditional futures are defined by expiration dates that are generally monthly or quarterly, and trading volume tends to be concentrated in monthly or quarterly futures that mature within three months to two years of a given trading date. Today, a party can buy (go long) 10-Eurodollar futures that expire in six months, and on any trading day in that six-month period, can re-enter the market and trade out of the initial position by selling (go short) 10-Eurodollar futures that carry the same expiration date. Regardless of the futures price negotiated for each trade, the result of the two trades is that the trader will have no liability and carry no position, or be “net flat” in futures industry parlance. The standardized nature of futures results in concentration of liquidity within the central limit order book, as multiple trading participants place bids and offers to trade a quarterly-expiring future at various prices.

The characteristics of cleared, interest rate swap derivatives (either interest rates swaps that are cleared or spot-starting interest rate swap futures with flexible coupons) imply significantly different trading and liquidity characteristics from traditional futures. A spot-starting instrument today is a different instrument from the spot-starting instrument traded tomorrow. And each coupon rate that trades as par for a given day and tenor is an independent instrument. Traditionally, the most frequently-traded spot-starting swaps have so-called standard maturity dates or standard tenors, traded in increments of one-year (for example, 2-year, 3-year, 5-year, 7-year, 10-year).

The granularization of instruments available for trading results in relatively low levels of open interest occurring for each individual instrument, which can add difficulty for a given trader to find willing buyers and sellers to act as counterparties at reasonable prices. This is referred to herein as the granularization issue.

Each financial instrument must have a value assigned to it for purposes of daily valuation, and in centrally-cleared markets, the clearinghouse assigns this value. To determine the value of a futures position, participants use price per future, then multiply that value by the total number of futures held by a counterparty. To determine the value of a swaps position, participants use NPV of remaining cash flows.

Eris Exchange, 311 South Wacker Drive, Suite 950, Chicago, Ill. 60606, a futures exchange operating as an Exempt Board of Trade under the jurisdiction of the Commodity Futures Trading Commission (CFTC), introduced Eris Exchange Interest Rate Swap Futures (“Eris IR Swap Futures”) in August 2010. This financial instrument is regulated as a future, but contains economic and flexibility characteristics typically associated with interest rate swaps. For example, Eris IR Swap Futures allow counterparties to initiate par swap positions by negotiating the fixed coupon rate, as described above. Participants can trade spot-starting instruments with effective dates t+2 (two business days after the trade date), that mature on any valid business day up to 30 years in the future. The product is cleared by the CME Group's CME Clearing, 20 South Wacker Drive, Chicago, Ill. 60606, and the daily mark-to-market valuation process for spot-starting Eris IR Swap Futures results in cash flows that are substantially similar to total cash flows that a participant would derive from an identically-structured OTC interest rate swap, assuming both contracts (the Eris IR Swap Future and the OTC interest rate swap) are valued daily using a common set of discount factors. This flexibility contrasts with the characteristics of the CME Group's Chicago Board of Trade 5-year and 10-year Interest Rate Swap futures (“CBOT swap futures”), which include a standard fixed rate of 4%, are not spot-starting, offer quarterly expirations (not daily), and do not replicate the economics of an equivalent swap position. By allowing participants to trade interest rate swap derivatives in a futures form, Eris Exchange permits multiple counterparties to submit anonymous bids and offers in a central limit order book through an electronic trading platform.

An important distinction lies between the characteristics of trading traditional futures in a central limit order book through negotiation of futures price, and the characteristics of trading par swap in a central limit order book through negotiation of fixed rates. A market participant that submits a large market order into the central limit order book of a traditional futures product will cause a series of trades to occur at multiple price levels, as many prices as are necessary to fill the entire demanded quantity (assuming that the requested quantity on the order was larger than the available quantity at the best price level). The electronic trading platform will match the order according to the matching methodology, and will transmit information back to the market participant regarding multiple trades that occur at multiple price levels. Regardless of how many trades occur and how many price levels are involved, the market participant will have a single net position in a single financial instrument at the conclusion of the order matching.

For example, consider a hypothetical scenario for a traditional futures market like CME e-mini S&P futures. Assume that within the central limit order book of the future that expires in March 2013, there are four resting orders:
Bid #1: 60 futures at a price of 1210
Offer #1: 20 futures at a price of 1212
Offer #2: 30 futures at a price of 1213
Offer #3: 15 futures at a price of 1215

A market participant that submits a market order to buy 60 futures will become a counterparty to three trades:
Trade #1: 20 futures at a price of 1212
Trade #2: 30 futures at a price of 1213
Trade #3: 10 futures at a price of 1215

This example demonstrates that in order to buy 60 futures, the market participant was required to lift offers at three distinct price levels. All three trades are for the same instrument: March 2016 CME e-mini S&P futures. The final result is that the market participant has a net position of Long 60 futures:
Long 60 futures for the CME e-mini S&P futures that expire March 2016

To illustrate this point further, note that the market participant could proceed to liquidate her entire position by submitting a single market order to sell 60 futures, which would be filled in one trade against the resting bid (Bid #1):
Trade #4: 60 futures at a price of 1210
   The result of this fourth trade is that the market participant is flat; she has a net position of zero.

On the other hand, a market participant that submits a similar order into a central limit order book of a swap derivative where counterparties negotiate the par coupon will not only result in multiple trades at multiple price levels, it will result in open positions in multiple financial instruments. When used herein, swap derivative encompasses both swaps and swap futures. This inherent limitation of par swap derivatives is referred to herein as the multiple position issue.

As a second example, consider a hypothetical scenario for a spot-starting 10-year Eris IR Swap future, in which the buyer of the future agrees to be the fixed leg payer (floating leg receiver) on a swap derivative, and a seller agrees to be the fixed leg receiver (floating leg payer). Assume that within the central limit order book of today's 10-year future there are four resting orders, similar in structure to the first example:
Bid #1: 60 futures at a fixed rate of 3.442%
Offer #1: 20 futures at a fixed rate of 3.445%
Offer #2: 30 futures at a fixed rate of 3.446%
Offer #3: 15 futures at a price of 3.448%
   A market participant that submits a market order to buy 60 futures will become a counterparty to three trades:
Trade #1: 20 futures at a fixed rate of 3.445%
Trade #2: 30 futures at a fixed rate of 3.446%
Trade #3: 15 futures at a fixed rate of 3.448%

Similar to the previous example, in order to buy 60 futures, the market participant was required to lift offers at three distinct fixed rate levels. Unlike the previous example, however, the result is that the market participants now has net positions in three distinct, non-fungible financial instruments:
Long 20 futures for the 5-year tenor, spot-starting Eris IR Swap Futures with a 3.445% coupon
Long 30 futures for the 5-year tenor, spot-starting Eris IR Swap Futures with a 3.446% coupon
Long 10 futures for the 5-year tenor, spot-starting Eris IR Swap Futures with a 3.448% coupon

Furthermore, consider a fourth trade in which the market participant sells 60 futures by hitting the bid at the prevailing rate of 3.442%:
Trade #4: 60 futures at a fixed rate of 3.442%
   Unlike the previous example where the fourth trade in the sequence resulted in the market participant being flat (i.e., having no net position in the market), in this case the fourth trade results in an additional open position:
Long 20 futures for the 5-year tenor, spot-starting Eris IR Swap Future with a 3.445% coupon
Long 30 futures for the 5-year tenor, spot-starting Eris IR Swap Future with a 3.446% coupon
Long 10 futures for the 5-year tenor, spot-starting Eris IR Swap Future with a 3.448% coupon
Short 60 futures for the 5-year tenor, spot-starting Eris IR Swap Future with a 3.442% coupon
   In order for the market participant in this example to flatten her position and exit all open positions, she must place orders resulting in off-setting trades for each of the four futures.

Users of traditional futures often take advantage of so-called average pricing systems (APS), a feature that allows them to use volume-weighted averaging of multiple executions. Among the multiple benefits of using an APS is a broker firm can execute on behalf of multiple customers with a single order, and then allocate the executions to each customer at the volume weighted average price of the resulting trades, to ensure all customers receive fair treatment compared to other customers.

For example, in the first example, above, assume that the market participant is a broker that is executing a single market order to buy 60 futures as a convenient way to go long on behalf of six individual customers who each seek to go long 10 futures. Exchange and regulatory restrictions require the broker to treat all customers equally with respect to quality of prices for fills on similar orders, but in the case of the Trades 1-3 in the first example, the broker will be forced to allocate trades at unequal prices among equal customers. One solution to this problem is for the broker to utilize APS functionality that is offered by several trading and clearing venues, including CME Clearing. In the case of the first example, the volume-weighted average price of the Trade #1, #2 and #3 is 60 futures at a price of 1213, thereby allowing the broker to allocate trades to customers at equivalent prices.

In the case of the second example, however, a broker would not be able to utilize APS functionality, since the submission of a single order results not in multiple trades within a single future, but individual trades within separate futures. Clearinghouses currently offer APS functionality only to average prices within an individual future, and do not permit participants to average fills across instruments. This lack of ability to use APS functionality across multiple positions is a significant drawback to any product that suffers from the multiple position issue.

While swaps have traditionally been uncleared, recently there has been pressure to migrate swaps to central clearing, including mandates set forth in the Dodd-Frank Wall Street Reform and Consumer Protection Act (the “Dodd-Frank Act”) (Pub.L. 111-203, H.R. 4173) signed into law by President Obama on 21 Jul. 2010. As a result of political pressure for greater transparency of uncleared financial instruments, the Dodd-Frank Act was passed into law in the wake of the 2008/2009 financial crisis. During the 2008/2009 financial crisis, many participants in uncleared financial instruments faced counterparties that were unable to meet their obligations.

As described above, existing swap derivatives instruments carry certain advantages and disadvantages in terms of structure. Overcoming the trade-offs that have traditionally been inherent in trading par swaps, off-market swaps, and futures in this new, government regulated environment has proven to be a significant challenge. At first glance, it would seem that the solution to these issues could all be addressed through the creation of a futures product for forward-starting swaps in a standardized coupon. By listing futures that are forward-starting and with a standardized coupon, the effects of the granularization issue are mitigated. And futures need not impose upfront payments, thus avoiding the upfront payment issue.

The Chicago Board of Trade's 10-Year Interest Rate Swap Futures attempts to list futures products with the economics of forward-starting swaps based on a standardize coupon. See http://www.cmegroup.com/trading/interest-rates/files/IR145_SwapFClo-res_web.pdf (accessed May 17, 2011). However, after multiple years of existence, these 10-Year Interest Rate Swap Futures trade at daily volume levels that are low relative to the volume of the interest rate swaps market, suggesting that market has failed to adopt them as true substitutes for interest rate swaps. Open interest for this futures, as of May 17, 2011 was reported by CME Group (http://www.cmegroup.com/daily_bulletin/preliminary_voi/VOIREPORT.pdf, accessed May 17, 2011) to be 11,694 contracts, which equates to $1.69 billion of notional value, compared to $364 trillion dollars of notional value of open interest for interest rate derivatives that ISDA estimated in March, 2011 (http://online.wsj.com/article/BT-CO-20110329-709826.html, accessed May 17, 2011), or 0.0003%.

Assessing the potential success or even explaining the lack of success of futures products is not straightforward, as a thriving futures market requires the confluence of a large number of factors, such as product design, distribution, technology, liquidity, and macroeconomics forces. Issues related to the design of the CBOT Swap Future that may contribute to its lack of commercial success include, the product only allows traders to transact a single coupon rate, imposing rigid standardization to minimize the granularization issue. The rate was 6.0% for contracts that expired from the inception of the product until December 2009, and has been set by the exchange at 4.0% since that time. In addition, the CBOT Swap Future is “traded in price and quoted in points”, as per the CBOT web site, rather than the par coupon or NPV protocols more familiar to the swap market. http://www.cmegroup.com/trading/interest-rates/files/IR145_SwapFC_lo-res_web.pdf (accessed May 17, 2011).

Another issue related to the design of the CBOT Swap Future that may contribute to its lack of commercial success is, the product doesn't seek to mimic the economics of a swap over the entire maturity of the swap: the product expires and is cash-settled at the conclusion of the forward-period of the swap. For example, the September 2011 CBOT 10-year Interest Rate Swap Future expires Sep. 19, 2011, at which point the position is settled by the clearing house and open interest ceases to exist. A comparable OTC interest rate swap implies that the forward-period ends in September 2011, but the swap itself does not mature until September, 2021. In addition, the CBOT Swap Future uses simple present value analysis, rather than adhering to swap convention of discounting cash flows at LIBOR or overnight indexed swap (OIS) rates.

Rigid standardization, deviation from OTC trading protocols, and expiration after the forward-period are the most prominent characteristics in which the CBOT Interest Rate Swap Future deviates from the construction of OTC interest rate swaps.

As of May 2011, Eris Exchange's Eris IR Swap Futures have been offered as par swaps, but the product is easily adaptable to a forward-starting swap model. The construction of this future product mitigates several of the issues that have hampered the product design of the previous attempts at migrating swaps volume into futures products. However, Eris IR Swap Futures does not mitigate the granularization issue or overcome the preference for par swaps issue without raising the multiple position issue.

### SUMMARY OF THE INVENTION

A rate-negotiated, standardized-coupon financial instrument and method of trading in accordance with the principles of the present invention combines the advantages of the Eris IR Swap Futures in a forward-starting fashion that both mitigates the granularization issue by offering multiple, standardized coupons, but also overcomes the preference for par swaps issue without raising the multiple position issue. A rate-negotiated, standardized-coupon financial instrument in accordance with the principles of the present invention includes a coupon negotiated between two parties. At least one forward curve and a discount curve are implied or approximated to be consistent with the negotiated coupon. A consistent value for a swap with a different coupon is determined. The consistent value can comprise the net present value (NPV) of the interest rate swap written as the difference between the present values of two interest payment legs. In the case of a vanilla swap the two legs correspond to fixed coupon payments and floating coupon payments. In the case of a basis swap, one leg is the floating coupon payments with a reference rate plus a fixed coupon, and the other leg is floating coupon payments with a different reference rate. The rate-negotiated, standardized-coupon financial instrument of the present invention provides for a financial instrument negotiated in rate terms to be substituted with an equivalent position in an instrument with a different coupon rate, at an adjusted price.

### BRIEF DESCRIPTION OF THE DRAWING

FIG. 1 is a flow-chart setting forth an example for determining the net present value (NPV) of an interest rate swap (receiver).

FIG. 2 is a flow-chart setting forth an example for determining the net present value (NPV) of an interest rate swap (receiver).

FIG. 3 is a flow-chart setting forth an example for determining the net present value (NPV) of a basis swap (receiver).

FIG. 4 is a non-limiting example of a hardware infrastructure that can be used to run a system that implements electronic trading of a rate-negotiated, standardized-coupon financial instrument of the present invention.

### DETAILED DESCRIPTION OF A PREFERRED EMBODIMENT

While an exemplary embodiment of the invention illustrated and described has been built to trade on Eris Exchange, 311 South Wacker Drive, Suite 950, Chicago, Ill. 60606, it will be appreciated that the present invention is not so limited and can be traded on other exchanges or trading platforms, regardless of whether located in the United States or abroad, traded through a private negotiation, traded in currencies other than United States dollars or traded as a future or as a cleared swap or other type of financial instrument. When used herein, the terms exchange and trading platform refer broadly to a marketplace in which securities, commodities, derivatives and other financial instruments are traded, and includes but is not necessarily limited to designated markets, exempt boards of trade, designated clearing organizations, securities exchanges, swap execution facilities, electronic communications networks, and the like.

As previously detailed, as of May 2011 Eris Exchange's Eris IR Swap Futures have been offered as par swaps, with the product easily adaptable to a forward-starting swap model. The construction of this future product mitigates several of the issues that have hampered the product design of the previous attempts at migrating swaps volume into futures products. Consider the possibility of listing a version of Eris IR Swap Futures for forward-starting, par swaps trading in rate terms. This product would reduce the granularization issue, through its forward-starting nature. As a future cleared by CME Clearing using a method that does not require bilateral payments, the product mitigates the upfront payment issue. Since the product is traded in rate terms, traders would be operating in a familiar pricing environment that is supported by numerous pricing tools. Since this product matures at the end of the swap tenor, rather than the end of the forward-period, it more closely resembles an OTC interest rate swap. On the other hand, the granularization issue and multiple position issue associated with negotiating par coupons would not be mitigated, resulting in a proliferation of open interest across multiple coupons, rather than a concentration of liquidity in smaller number of futures.

Next, consider the alternative possibility of listing a version of Eris IR Swap Futures for forward-starting, off-market swaps traded in NPV, with multiple standardized coupons. This product would mitigate the granularization issue more completely than the previous alternative, by its forward-starting nature and by pooling liquidity into a standard set of coupons. As a future, the product mitigates the upfront payment issue. Trading the future in NPV terms is attractive in that it follows OTC convention, and mitigates the multiple position issue; however, the product would still suffer from the preference for par swaps issue, since it is not traded in rate.

What is thus desirable would be a product that combines the advantages of the Eris IR Swap Futures in a forward-starting fashion that both mitigates the granularization issue by offering multiple, standardized coupons, but also overcomes the preference for par swaps issue without raising the multiple position issue.

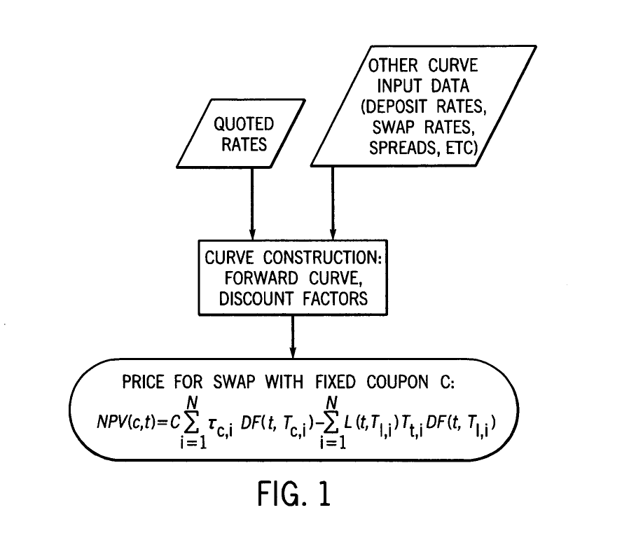

The present invention provides a mechanism whereby a financial instrument negotiated in rate terms can be substituted with an equivalent position in an instrument with a different coupon rate, at an adjusted price. When used herein, the term equivalent means nearly equal in amount, value, measure, force, effect, significance, etc., and encompasses an instrument with a different coupon rate, at an adjusted price, having nearly-equivalent but economically satisfactory position. In accordance with the principles of the present invention, a rate-negotiated, standardized-coupon financial instrument and method of trading are provided. Referring first to FIG. 1, a flow-chart is seen setting forth the general example for determining the net present value (NPV) of a vanilla interest rate swap. Quoted rates and other curve input data such as for example deposit rates, swap rates, spreads, etc. are input into a curve constructor. The net present value (NPV) of the vanilla interest rate swap (receiver) can be written as the difference between the present value of fixed coupon payments and floating coupon payments. The price for a swap with a fixed coupon F is:

$$NPV ( c , t ) = c {\sum }_{i = 1}^{N} {τ}_{c , i} DF ( t , {T}_{c , i} ) - {\sum }_{i = 1}^{N} L ( t , {T}_{l , i} ) {τ}_{l , i} DF ( t , {T}_{l , i} ) \qquad Equation 1$$

where,
   L(t,T_{l,i}) is the forward rate at t, relevant to the floating payment at T_{l,i};
   DF(t,s) is the discount factor from t to s, t≦s; and
   τ_{c,i},τ_{l,i}, are the year fractions of the accrual period for fixed and floating payments respectively.
      The discount rates and forward rates may or may not be derived from the same yield curve. For example, when modeling vanilla interest rate swaps before 2007, the market practice was to use a LIBOR curve to derive both rates; post the financial-crisis, the growing consensus has migrated to use of the OIS curve to derive discount rates, and a LIBOR curve to calculate the forward rates. Various assumptions and curve construction methodology do not affect the application of the present invention.

In accordance with the principles of the present invention, while a coupon is negotiated between two parties, the forward curve and discount curve are implied or approximated to be consistent with the negotiated coupon. Then a net present value such as for example the above NPV Equation 1 can be used or approximated to generate a consistent value for a swap with a different coupon.

Denoting the summation

$${\sum }_{i = 1}^{N} {τ}_{c , i} DF ( t , {T}_{c , i} )$$

by A(t), A(t) is called the annuity of the swap, also known as present value of a basis point (PV01), and is determined by the discount (funding) curve. For two swaps that have the same characteristics—floating leg index, start date, payment schedules, day count, and holiday conventions—the difference in NPV is:

NPV(c₁,t)−NPV(c₂,t)=(c₁−c₂)A(t) Equation 2

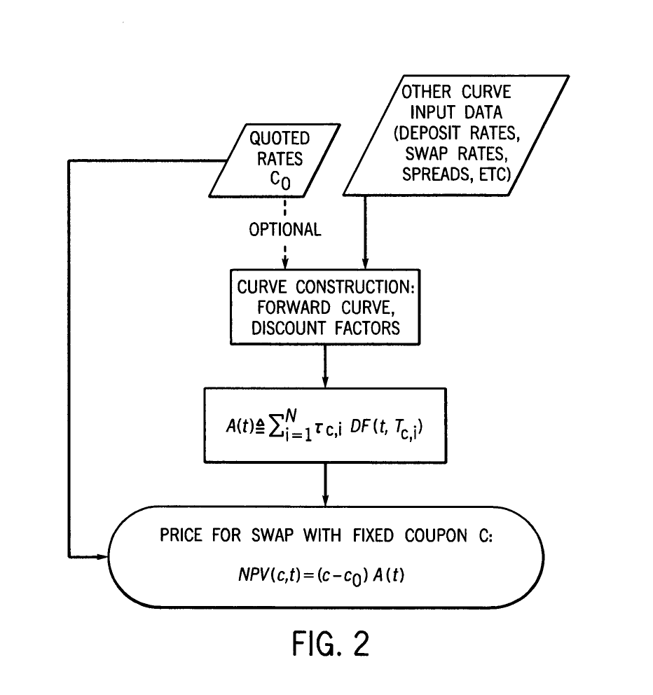

Based on this observation, another embodiment of a rate-negotiated, standardized-coupon financial instrument and method of trading can be provided. Referring to FIG. 2, a flow-chart is seen setting forth a second example for determining the net present value (NPV) of an interest rate swap. Trades can be negotiated and quoted in par swap rate. Let c₂ be a quoted rate, it implies NPV(c₂,t)=0. Then a swap with a given coupon c₁ can be assigned with a NPV equal to

$$( {c}_{1} - {c}_{2} ) {\sum }_{i = 1}^{N} {τ}_{c , i} DF ( t , {T}_{c , i} ) .$$

In order to compute the annuity, input data such as deposit rates, swap rates, spreads, etc. are needed for the curve construction; however, the quoted par swap rate may or may not be used in the curve construction.

In another embodiment of the present invention, the NPV of a given coupon, together with its sensitivity with respect to the change in the par swap rate, can be pre-computed. The sensitivity is often referred to as “DV01”. Let C1 be the fixed coupon, and assume that at time t₀ the swap with the same characteristics has a par coupon of c₀. The prevailing forward curve and discount curve are used to compute NPV(c₁,t₀), and

$$DV 01 ( {c}_{1} , {t}_{0} ) = \frac{\partial NPV ( {c}_{1} , {t}_{0} )}{\partial {c}_{0}} .$$

At time t when a trade is negotiated in terms of the par coupon c, then a swap with the given coupon c₁ can be assigned with a value of

NPV(c₁,t)≈NPV(c₁,t₀)+DV01(c₁,t₀)×(c−c₀) Equation 3

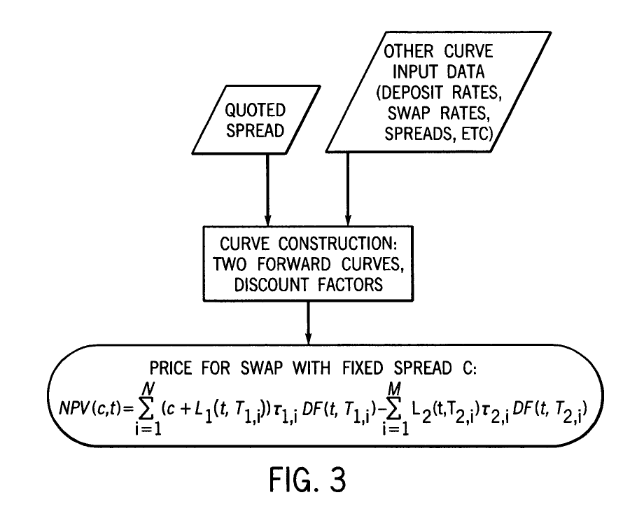

Referring to FIG. 3, a flow-chart is seen setting forth the general example for determining the net present value (NPV) of a basis swap in accordance with the principles of the present invention. The NPV of the basis swap can be written as the difference between the present value of two legs of floating coupon payments. The price for a swap with a fixed coupon c is:

$$NPV ( c , t ) = {\sum }_{i = 1}^{N} ( c + {L}_{1} ( t , {T}_{1 , i} ) ) {τ}_{1 , i} DF ( t , {T}_{1 , i} ) - {\sum }_{i = 1}^{M} {L}_{2} ( t , {T}_{2 , i} ) {τ}_{2 , i} DF ( t , {T}_{2 , i} ) , \qquad Equation 4$$

where,
   L₁1(t,T₁(1,i)), L₁2(t,T₁(2,i)) are the rates at t determined by two forward curves, relevant to the floating payments at T_{1,i},T_{2,i}, respectively;
   DF(t,s) is the discount factor from t to s, t≦s; and
   τ_{1,i},τ_{2,i} are the year fractions of the accrual periods of the two floating payments respectively.

The coupon in a basis swap often indicates the difference between the two forward curves. Similar to the vanilla swaps, while a coupon is negotiated between two parties, the forward curves and discount curve are implied or approximated to be consistent with the negotiated coupon. Then a net present value such as for example the above NPV Equation 4 can be used or approximated to generate a consistent value for a swap with a different coupon.

Same methods of determining the fixed-coupon swap price from a negotiated coupon that apply to vanilla swaps can be applied to basis swaps as well. For example, denoting the summation

$${\sum }_{i = 1}^{N} {τ}_{1 , i} DF ( t , {T}_{1 , i} )$$

by A(t), for two swaps that have the same characteristics—floating leg indices, start date, payment schedules, day count, and holiday conventions—the difference in NPV is:

NPV(c₁,t)−NPV(c₂,t)=(c₁−c₂)A(t).

Let c₂ be a quoted par coupon, it implies NPV(c₂,t)=0. Then a basis swap with a given coupon c₁ can be assigned with a NPV equal to (c₁−c₂)A(t). In order to compute the annuity, input data such as deposit rates, swap rates, spreads, etc. are needed for the curve construction; however, the quoted par swap rate may or may not be used in the curve construction.

The derived NPV of a fixed coupon can be directly used as the price of the cleared swap. In another embodiment in accordance with the present invention, a constant can be added or subtracted from the NPV to obtain the price. Generally the profit and loss of a cleared swap comes only from the price change, and, thus, modifying the price process by a constant does not affect the nature of the swap.

The following are non-limiting examples of converting a negotiated coupon to a price for a swap with a fixed coupon. Unless specified otherwise, the NPV of the fixed coupon swap is used as the price, and all NPV's are calculated from the perspective of the receiver.

### Example 1

This example shows the negotiated par coupon for a spot starting swap can be converted to a price for fixed coupon swap using Equation 1 directly.

Consider a spot starting 10-year LIBOR interest rate swap with notional amount of $1,000,000. The fixed coupon is set to be 3.5%, and the trades are negotiated in terms of the par coupon. Assume that the discounting curve is an OIS curve, and the forward curve is a LIBOR curve. A set of LIBOR swap rates, Eurodollar rates, and swap spreads are used to construct the OIS curve and LIBOR curve. When a trade is consummated, and a par coupon is agreed on, this coupon is passed in as an input to the yield curve construction, and forward rates and discount factors are updated accordingly. Then Equation 1 is used to compute the price of the 3.5% swap. Table 1 is an example of the quoted coupon and the corresponding price:

TABLE 1

| Par coupon | 3.40 | 3.42 | 3.44 | 3.46 | 3.48 |
|---|---|---|---|---|---|
| Price | 8832 | 7065 | 5298 | 3531 | 1765 |

### Example 2

This example shows the negotiated par coupon for a spot starting swap can be converted to a price for fixed coupon swap using Equation 2. This yields the same result as in Example 1.

Consider the same spot starting 10-year LIBOR interest rate swap with notional amount of $1,000,000 as in Example 1. Because the change in the swap rates effects the discounting (OIS) curve by the curve construction method in the current example, the annuity in Equation 2 needs to be updated when the par coupon is quoted in a trade. Table 2 shows the annuity as well as the price for the 3.5% coupon swap at different levels of the quoted par coupon:

TABLE 2

| Par coupon | 3.40 | 3.42 | 3.44 | 3.46 | 3.48 |
|---|---|---|---|---|---|
| Annuity | 883.21 | 883.09 | 882.97 | 882.85 | 882.73 |
| Price | 8832 | 7065 | 5298 | 3531 | 1765 |

Take the third column, for example, with the quoted par coupon=3.44%, the price for the 3.5% coupon is 100*(3.5−3.44)*882.97=5298.

### Example 3

This example shows a good approximation is obtained when the annuity Mt) is pre-computed. The same set-up as in Example 2 is used.

In most of the curve construction methodology, the sensitivity of the annuity with respect to the par coupon is small, if exists at all. Therefore in practice, the annuity can be pre-computed and published periodically. When a par coupon is negotiated in a trade, it can be directly plugged into Equation 2 to compute the price without updating A(t).

Consider the same swap example as in Example 2. Assume that the annuity of 882.97 is the latest update when the market prevailing 10-year swap rate is 3.44%. Table 3 shows the conversion from quoted par coupon to the price of 3.5% coupon swap using the fixed annuity:

TABLE 3

| Par coupon | 3.40 | 3.42 | 3.44 | 3.46 | 3.48 |
|---|---|---|---|---|---|
| Annuity | 882.97 | 882.97 | 882.97 | 882.97 | 882.97 |
| Price | 8830 | 7064 | 5298 | 3532 | 1766 |

Take the first column, for example, with the quoted par coupon=3.4%, the price for the 3.5% coupon is 100*(3.5−3.40)*882.97=8830.

### Example 4

This example shows the negotiated par coupon for a spot starting swap can be converted to a price for fixed coupon swap using Equation 3, the DV01 method, with very small approximation error.

Consider the same swap as in the previous examples. Assume that the NPV and DV01 of a 3.50% coupon swap are calculated when the prevailing 10-year swap rate is 3.44%, If it turns out that NPV(3.5%,t₀)=5298 and DV01(3.5%,t₀)=−883.36, the Table 4 shows the conversion result using Equation 3:

TABLE 4

| Par coupon | 3.40 | 3.42 | 3.44 | 3.46 | 3.48 |
|---|---|---|---|---|---|
| DV01 | −883.36 | −883.36 | −883.36 | −883.36 | −883.36 |
| Price | 8831 | 7065 | 5298 | 3531 | 1764 |

Take the first column, for example, with the quoted par coupon=3.4%, the price for the 3.5% coupon is 5298−100*(3.4−3.44)*883.36=8831.

All the previous examples can be applied to forward-starting swaps.

### Example 5

This example shows Equation 2 can be used to convert the negotiated par coupon for a forward starting swap to a consistent price for a fixed coupon forward swap that has the same starting date and maturity date.

Consider a 3-month forward starting 10-year interest rate swap with a notional amount of $1,000,000. Assume that the annuity of such a forward swap is equal to 875.63 when the prevailing par coupon of the 3-month forward 10-year swap is 3.5653%. Table 5 shows the conversion result:

TABLE 5

| Par coupon | 3.52 | 3.54 | 3.56 | 3.58 | 3.60 |
|---|---|---|---|---|---|
| Annuity | 875.63 | 875.63 | 875.63 | 875.63 | 875.63 |
| Price | −1751 | −3503 | −5254 | −7005 | −8756 |

### Example 6

This example shows Equation 2 can be used to convert the negotiated par spread for a spot-starting basis swap to a consistent price for a fixed-spread basis swap with the same terms.

Consider a spot starting 10-year 3/6 LIBOR basis swap with notional amount of $1,000,000. The fixed spread is set to be 0.05%, or 5 basis points (bp), and the trades are negotiated in terms of the par spread. Assume that the discounting curve is an OIS curve, one forward curve is constructed from LIBOR with 3 month tenor (the interest accrual period), and the other forward curve is constructed from LIBOR with 6 month tenor. A set of LIBOR swap rates, Eurodollar rates, and swap spreads are used to construct these curves. Assuming the annuity is pre-computed and equal to 879.35 at the time of the trade, then the negotiated par spread is passed into Equation 2 to compute the price of the basis swap with 5 bp spread. The following table shows the corresponding prices for the different negotiated par spreads:

TABLE 6

| Par spread (bp) | 4.8 | 4.9 | 5.0 | 5.1 | 5.2 |
|---|---|---|---|---|---|
| Annuity | 879.35 | 879.35 | 879.35 | 879.35 | 879.35 |
| Price | 175.88 | 87.94 | 0 | −87.94 | −175.88 |

Again, the foregoing are non-limiting examples of converting a negotiated coupon to a price for a swap with a fixed coupon.

Coupling an embodiment of the present invention with a spot-starting swap derivative with multiple standardized coupons permits the creation of an instrument that lessens the effect of the granularization issue through coupon standardization, without sacrificing the ability to negotiate the product in rate terms to overcome the preference for par swaps issue. The conversion from coupon-negotiated value to a new position at a different price, using one of the methods the present invention, can occur at the time the trade occurs or at the end of a period, such as the trading day. The conversion can be effected by one of several components or actors in the trading process: the execution venue (e.g. a futures exchange or swap execution facility) or the central counterparty (e.g., a Designated Clearing Organization), or in less likely cases, a clearing firm or market participant.

According to the principles of the present invention, in order to publish daily and terminal settlement values a clearinghouse, exchange, futures commission merchant or other market participant may use computers with software specifically designed for this purpose. The computation of the terminal value in accordance with the present invention is iterative and complex, and special software is required for this purpose. This software may be linked to a centralized marketplace via data lines, networks or the Internet, so that the prices are published in a seamless manner. The clearing house may store the daily prices for each financial instrument in existence at any given moment in a database that can be electronically published to the marketplace.

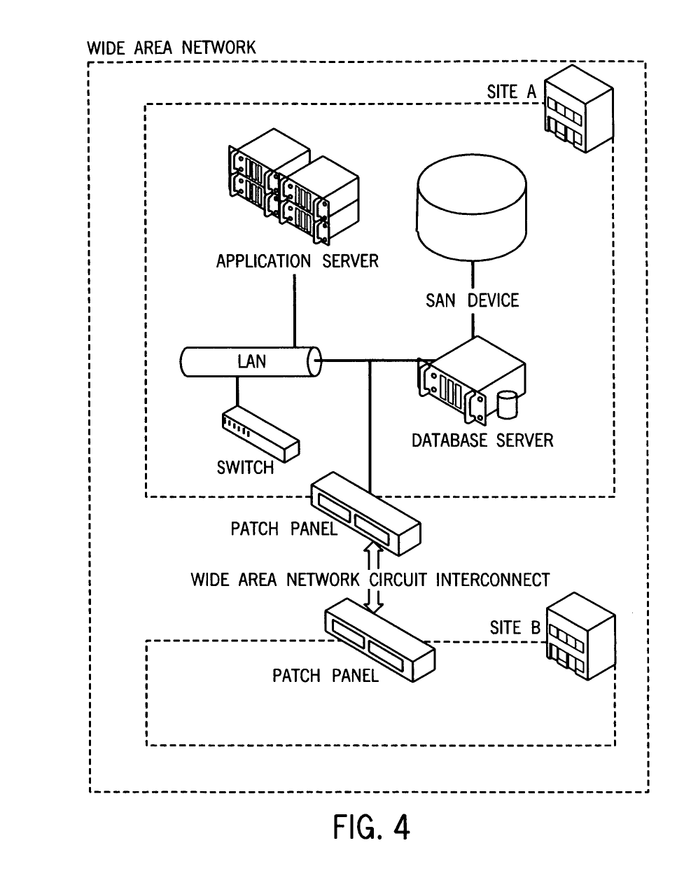

Referring now to FIG. 4, a non-limiting example of a high level hardware implementation can used to run a system of the present invention is seen. The infrastructure should include but not be limited to: wide area network connectivity, local area network connectivity, appropriate network switches and routers, electrical power (backup power), storage area network hardware, server-class computing hardware, and an operating system such as for example Redhat Linux Enterprise AS Operating System available from Red Hat, Inc, 1801 Varsity Drive, Raleigh, N.C.

The clearing and settling and administrative applications software server can run for example on an HP ProLiant DL 360 G6 server with multiple Intel Xeon 5600 series processors with a processor base frequency of 3.33 GHz, up to 192 GB of RAM, 2 PCIE expansion slots, 1 GB or 10 GB network controllers, hot plug SFF SATA drives, and redundant power supplies, available from Hewlett-Packard, Inc, located at 3000 Hanover Street, Palo Alto, Calif. The database server can be run for example on a HP ProLiant DL 380 G6 server with multiple Intel Xeon 5600 series processors with a processor base frequency of 3.33 GHZ, up to 192 GB of RAM, 6 PCIE expansion slots, 16 SFF SATA drive bays, an integrated P410i integrated storage controller, and redundant power supply, available from Hewlett-Packard.

While the invention has been described with specific embodiments, other alternatives, modifications, and variations will be apparent to those skilled in the art. Accordingly, it will be intended to include all such alternatives, modifications and variations set forth within the spirit and scope of the appended claims.

What is claimed is:

1. A method of creating a rate-negotiated, standardized-coupon financial instrument comprising:
negotiating a coupon between two parties;
electronically implying or approximating at least one forward curve and a discount curve to be consistent with the negotiated coupon on at least one processor; and
electronically determining a consistent value for a swap with a different coupon on at least one processor;
whereby a financial instrument negotiated in rate terms can be substituted with an equivalent position in an instrument with a different coupon rate, at an adjusted price.

2. The method of creating a rate-negotiated, standardized-coupon financial instrument of claim 1 further wherein electronically determining the consistent value for a swap with a different coupon comprises determining the net present value (NPV) of the interest rate swap written as the difference between the present values of two interest payment legs.

3. The method of creating a rate-negotiated, standardized-coupon financial instrument of claim 2 further wherein electronically determining the consistent value for a swap with a different coupon comprises determining the net present value (NPV) of the interest rate swap written as the difference between the present values of fixed coupon payments and floating coupon payments.

4. The method of creating a rate-negotiated, standardized-coupon financial instrument of claim 2 further wherein electronically determining the consistent value for a swap with a different coupon comprises determining the net present value (NPV) of the interest rate swap written as the difference between the present values of floating coupon payments with a reference rate plus a fixed coupon and floating coupon payments with a different reference rate.

5. The method of creating a rate-negotiated, standardized-coupon financial instrument of claim 2 further wherein electronically determining the consistent value for a swap with a different coupon comprises utilizing:
$$NPV ( c , t ) = c {\sum }_{i = 1}^{N} {τ}_{c , i} DF ( t , {T}_{c , i} ) - {\sum }_{i = 1}^{N} L ( t , {T}_{l , i} ) {τ}_{l , i} DF ( t , {T}_{l , i} )$$
where,
c is a fixed coupon;
L(t,T_{l,i}) is the forward rate at t, relevant to the floating payment at T_{l,i};
DF(t,s) is the discount factor from t to s, t≦s; and
τ_{c,i},τ_{l,i}, are the year fractions of the accrual period for fixed and floating payments respectively.

6. The method of creating a rate-negotiated, standardized-coupon financial instrument of claim 2 further wherein electronically determining the consistent value for a swap with a different coupon comprises utilizing:
NPV(c₁,t)−NPV(c₂,t)=(c₁−c₂)A(t),
where,
c₁ is a fixed coupon;
c₂ is a quoted par swap rate, implying NPV(c₂,t)=0 . . . ; and
$$A ( t ) {=}^{Δ} {\sum }_{i = 1}^{N} {τ}_{c , i} DF ( t , {T}_{c , i} ) ,$$

7. The method of creating a rate-negotiated, standardized-coupon financial instrument of claim 2 further wherein electronically determining the consistent value for a swap with a different coupon comprises utilizing:
NPV(c₁,t)≈NPV(c₁,t₀)+DV01(c₁,t₀)×(c−c₀)
where,
c₁ is a fixed coupon; and
c is the quoted par coupon.

8. The method of creating a rate-negotiated, standardized-coupon financial instrument of claim 2 further comprising determining the consistent value for a swap with a different coupon by utilizing:
$$NPV ( c , t ) = {\sum }_{i = 1}^{N} ( c + {L}_{1} ( t , {T}_{1 , i} ) ) {τ}_{1 , i} DF ( t , {T}_{1 , i} ) - {\sum }_{i = 1}^{M} {L}_{2} ( t , {T}_{2 , i} ) {τ}_{2 , i} DF ( t , {T}_{2 , i} ) ,$$
where,
c is a fixed coupon;
L_{↓}1(t,T_{↓}(1,i)), L_{↓}2(t,T_{↓}(2,i) are the rates at t determined by two forward curves, relevant to the floating payments at T_{1,i},T_{2,i}, respectively;
DF(t,s) is the discount factor from t to s, t≦s; and
τ_{1,i},τ_{2,i} are the year fractions of the accrual periods of the two floating payments respectively.

9. The method of creating a rate-negotiated, standardized-coupon financial instrument of claim 1 further wherein electronically implying or approximating the at least one forward curve and the discount curve comprises using a London InterBank Offered Rate (LIBOR) curve.

10. The method of creating a rate-negotiated, standardized-coupon financial instrument of claim 1 further wherein electronically implying or approximating the at least one forward curve comprises using a London InterBank Offered Rate (LIBOR) curve and electronically implying or approximating the discount curve comprises using an overnight indexed swap (OIS) curve.

11. The method of creating a rate-negotiated, standardized-coupon financial instrument of claim 1 further including adding or subtracting a constant from the NPV to obtain the price.

12. The method of creating a rate-negotiated, standardized-coupon financial instrument of claim 1 further wherein electronically determining a consistent value for the swap with a different coupon comprises electronically determining a consistent value for a spot starting swap.

13. The method of creating a rate-negotiated, standardized-coupon financial instrument of claim 1 further wherein electronically determining a consistent value for the swap with a different coupon comprises electronically determining a consistent value for a forward-starting swap.

14. The method of creating a rate-negotiated, standardized-coupon financial instrument of claim 1 further comprises creating a rate-negotiated, standardized-coupon cleared swap.

15. The method of creating a rate-negotiated, standardized-coupon financial instrument of claim 1 further comprises creating a rate-negotiated, standardized-coupon future.

16. The method of creating a rate-negotiated, standardized-coupon financial instrument of claim 1 further including selecting the at least one microprocessors from the group comprising one processor, more than one processor, and combinations thereof.

17. A rate-negotiated, standardized-coupon financial instrument obtained by a process, the process comprising:
negotiating a coupon between two parties;
implying or approximating at least one forward curve and a discount curve consistent with the negotiated coupon; and
determining a consistent value for a swap with a different coupon;
whereby a financial instrument negotiated in rate terms can be substituted with an equivalent position in an instrument with a different coupon rate, at an adjusted price.

18. The rate-negotiated, standardized-coupon financial instrument obtained by a process of claim 17 further comprising determining the consistent value for a swap with a different coupon by utilizing the net present value (NPV) of the interest rate swap written as the difference between the present values of interest payment legs.

19. The rate-negotiated, standardized-coupon financial instrument obtained by a process of claim 18 further wherein electronically determining the consistent value for a swap with a different coupon comprises determining the net present value (NPV) of the interest rate swap written as the difference between the present values of fixed coupon payments and floating coupon payments.

20. The rate-negotiated, standardized-coupon financial instrument obtained by a process of claim 18 further wherein electronically determining the consistent value for a swap with a different coupon comprises determining the net present value (NPV) of the interest rate swap written as the difference between the present values of floating coupon payments with a reference rate plus a fixed coupon and floating coupon payments with a different reference rate.

21. A general-purpose digital computer programmed to carry out a series of steps, the series of steps to electronically clear and settle a rate-negotiated, standardized-coupon financial instrument comprising:
negotiating a coupon between two parties;
implying or approximating at least one forward curve and a discount curve consistent with the negotiated coupon; and
determining a consistent value for a swap with a different coupon;
whereby a financial instrument negotiated in rate terms can be substituted with a equivalent position in an instrument with a different coupon rate, at an adjusted price.

22. The general-purpose digital computer programmed to carry out a series of steps, the series of steps to electronically clear and settle a rate-negotiated, standardized-coupon financial instrument of claim 23 further comprising determining the consistent value for a swap with a different coupon by utilizing the net present value (NPV) of the interest rate swap written as the difference between the present values of interest payment legs.

23. A computer program product, comprising a computer usable medium having a computer readable program code embodied therein, the computer readable program code adapted to be executed to implement a method for clearing and settling a non-biased financial instrument, the method comprising:
negotiating a coupon between two parties;
implying or approximating at least one forward curve and a discount curve consistent with the negotiated coupon; and
determining a consistent value for a swap with a different coupon;
whereby a financial instrument negotiated in rate terms can be substituted with a equivalent position in an instrument with a different coupon rate, at an adjusted price.

24. A non-biased financial instrument comprising:
negotiating a coupon between two parties;
means for implying or approximating at least one forward curve and a discount curve consistent with the negotiated coupon; and
means for determining a consistent value for a swap with a different coupon;
whereby a financial instrument negotiated in rate terms can be substituted with a equivalent position in an instrument with a different coupon rate, at an adjusted price.
